(19) United States
(12) Patent Application Publication
(10) Pub. No.: US 2017/0011483 A1
(43) Pub. Date: Jan. 12, 2017

(54) SYSTEM AND METHOD FOR ELECTRONIC SIGNATURE CREATION AND APPLICATION

(71) Applicant: ClearNDA, LLC, Park Ridge, IL (US)

(72) Inventor: Carl Gatenio, Chicago, IL (US)

(73) Assignee: ClearNDA, LLC, Park Ridge, IL (US)

(21) Appl. No.: 15/204,293

(22) Filed: Jul. 7, 2016

Related U.S. Application Data
(60) Provisional application No. 62/190,700, filed on Jul. 9, 2015.

(51) Int. Cl. G06Q 50/18; G06F 3/0486; H04L 9/32; G06F 17/24

(52) U.S. Cl. CPC G06Q 50/188; G06F 17/24; G06F 3/0486; H04L 9/3247

(57) ABSTRACT

A system and method for electronic signature creation and application is disclosed. In particular, this disclosure relates to the placement of electronic signatures on a document, signature order automation, and electronic signature creation. In addition, the disclosed embodiments include the handling of documents within one collaborative party, as well as permissions of that document for an opposing party.

### CROSS-REFERENCE TO RELATED APPLICATIONS

This application claims the benefit of U.S. Provisional Application No. 62/190,700, filed Jul. 9, 2015, which is herein incorporated by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE DISCLOSURE

The present disclosure pertains generally to the field of electronic signature creation and application. More particularly, the present disclosure relates to a system and method for the placement of electronic signatures on a document.

### BACKGROUND

Contract negotiations involve multiple parties and multiple participants per party. Typically, a document is created by one party (the “Originating Party” or “Party A”) who invites an opposing party or counterparty to an agreement (the “Receiving Party” or “Party B”). Party A may have one or more users (User A1, User A2, and the like) who negotiate with one or more counterparties at Party B (User B1, User B2, and the like). Users within one party will often collaborate internally prior to submitting a document to their counterparty. Once an agreement is reached, each Party signs the document in a predetermined order.

Electronic signatures are becoming more prevalent and in some jurisdiction may have the same enforceability as standard paper signatures. However, electronic signatures are susceptible to alteration and copying to a degree far different than that of standard paper signatures. There is a clear need in the art to provide enhanced security features with respect to electronic signatures so that they may enjoy a similar level of confidence to standard paper signatures. The present disclosure addresses this and other issues.

### SUMMARY

Some embodiments of the present disclosure set forth a system and method for electronic signature creation and application. In some embodiments, the electronic signature creation method includes: receiving, by way of invitation to a site, direct document attachment or other notification and invitation to collaborate on a file; opening, editing, signing or otherwise changing contents of a file; processing, by at least one computing device, a file, wherein the processing includes determining a number or magnitude of changes; and removing all metadata and associated user-specific information upon submission of the document.

In an aspect of one embodiment, the first computing device is a server. In another aspect, the file is of a format including PDF, Microsoft Excel, Word, or PowerPoint. In still another aspect, the processing is spread over a network of a plurality of computing devices connected over at least one communication network. In yet another aspect, the plurality of computing devices includes the at least one computing device.

In another embodiment, a method is disclosed for applying a unique identifier to an applied signature. The method includes: applying a unique merged field to a static document to determine a location, size, and placement of the unique merged field; using a location of a placed image on a static image to populate a same location on a non-static image; and inserting the unique merged field, image, or other object that matches the location of the placed image on the static image.

In an aspect of one embodiment, the unique merged field is applied to a static document by dragging and dropping. In another aspect, the document contains a plurality of fields corresponding to various data fields belonging to individual users. In another aspect, the electronic signature creation method further includes: creating a watermark with unique document specific information or encryption key as a background to an applied signature; and watermarking the document with an associated encryption upon signature placement. In still another aspect, an object is applied to a document. In yet another aspect, an image is applied to a document. In another aspect, a photo is applied to a document.

In another embodiment, a method is disclosed for pre-determining a signing order for applying a signature or other user generated unique identifier to an electronic document. The method includes: receiving applied signatures for the electronic document; holding the applied signatures in escrow until completion of all actions pre-determined by a document creator; upon the completion of all actions pre-determined by the document creator, applying escrowed signatures; and in the event of further editing of the document, removing all escrowed signatures and invalidating escrow signature data.

In still another embodiment, a method is disclosed for pre-determining the signing order for applying a signature or other user generated unique identifier. The method includes: creating a document in which a signing order requires a document recipient (counterparty) signature before a document originator signature; receiving the document originator signature for a document prior to submission of the document to the document recipient (counterparty); enabling the document recipient (counterparty) to make edits or sign the document; and applying the document originator signature only upon the completion of the document recipient (counterparty) signature to the document.

In an aspect of one embodiment, the document is selected from a group consisting of: any type of Microsoft Office Document (Word, Excel, PowerPoint, or OneNote), plan, sketch, data, synopsis, graphic representation, drawing, design, or combination thereof. In another aspect, more than one document recipient must sign the document, more than one document originator must sign the document, or more than one document originator must sign the document and more than one document recipient must sign the document. In still another aspect, a catalyst for applying a document originator signature is a manager's approval. In yet another aspect, a different signing order is employed, including, but not limited to more than one document recipient, followed by more than one document originator. In another aspect, a different signing order is employed, including, but not limited to more than one Recipient Group (with one or more users required by Recipient Group) followed by one or more Originator Group (with one or more users per Originator Group), Recipient(s)/Originator, Recipient Group 1, Recipient Group 2, Recipient Group N, Originator 1, Originator 2, or combinations thereof.

In yet another embodiment, a method is disclosed for pre-determining the signing order for applying an ID object or other user generated unique identifier. The method includes: creating a document in which a signing order requires a document recipient (counterparty) ID object before a document originator ID object; receiving the document originator ID object to the document prior to submission of the document to the document recipient (counterparty); enabling the document recipient (counterparty) to make edits or apply an ID object the document; and applying the document originator ID object only upon the completion of the document recipient (counterparty) ID object to the document.

In another embodiment, a method is disclosed for managing versions, permissions, and access to a document during a collaboration process among multiple parties with multiple users per party. The method includes: segmenting permissions on a user and party basis to enable a hierarchy of permissions; upon a document being shared or submitted with a counterparty, cleansing metadata associated with the document to ensure confidentiality of information; during scrubbing metadata, identifying information pertaining to internal users that are identified to be hidden from the opposing party; and removing or reassigning information pertaining to a hidden user from the document; wherein metadata from hidden users is removed or reassigned to other visible users to maintain confidentially of hidden users.

Further aspects of the disclosed embodiments will be brought out in the following portions of the specification, wherein the detailed description is for the purpose of fully disclosing the various embodiments without placing limitations thereon.

### BRIEF DESCRIPTION OF THE DRAWING

The present application will be more fully understood by reference to the following figures, which are for illustrative purposes only. The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

FIG. 1 illustrates a functional diagram of the placement of the electronic signature on a static document according to one embodiment.

FIG. 2A illustrates a functional diagram of the signature itself which includes the unique document ID as a watermark to the signature field.

FIG. 2B illustrates a functional diagram showing the original creation of the signature, prior to applying the signature to the document.

FIG. 3 illustrates a functional diagram of version control with respect to User, Group, and Permission levels.

### DETAILED DESCRIPTION

Persons of ordinary skill in the art will understand that the present disclosure is illustrative only and not in any way limiting. Other embodiments of the presently disclosed system and method readily suggest themselves to such skilled persons having the assistance of this disclosure.

Each of the features and teachings disclosed herein can be utilized separately or in conjunction with other features and teachings to provide a system and method for electronic contract management. Representative examples utilizing many of these additional features and teachings, both separately and in combination, are described in further detail with reference to the attached figures. This detailed description is merely intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present system and method. However, it will be apparent to one skilled in the art that these specific details are not required to practice the teachings of the present system and method.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “determining,” “displaying,” “configuring,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present application also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

One embodiment of the present disclosure is a system and method for electronic signature creation and application. In some embodiments of the electronic signature creation system, deal-related contracts are treated differently when groups are internal to a company verses when groups are external to a company. The electronic signature creation system enables users to handle permissions both on a user and a group basis. Users within a party are able to view and compare interim versions of a document. When sharing a version with an opposing party, all interim documents are held confidential when using the electronic signature creation system. The electronic signature creation system employs a process that makes interim documents accessible to anyone within a party, but not to those on an opposing party ensures confidentiality of interim version. Furthermore, in one embodiment, the electronic signature creation system employs a process that includes automatically removing all historical document or metadata prior to submitting the document to a counterparty organization.

In one embodiment of the electronic signature creation system, a document typically contains a signature field where a specific user must place its signature upon completion. The identification, location, and placement of this signature are important factors to ensure an accurate contract. In one embodiment, the electronic signature creation system controls the identification, placement, and handling of the signature location. In another embodiment, electronic signature creation system uses the coordinates of an object on a static image (its X, Y coordinates) to populate the location on a non-static document. For the purpose of clarity, a static image is a photo, still, or otherwise non-editable image of an object, while a non-static document is one in which the document can still be altered by a user. In other embodiments, the location of an object on a non-static image is utilized to populate the location on a static image. Thus, the process of the electronic signature creation system has the ability to go back and forth between static and non-static images.

In other embodiments, the electronic signature creation system controls the signing order during the creation of a document. The creator of a document (“Originator”) may specify the signing order (i.e., Party B must sign, then Party A must sign). In one embodiment, the parties will be prevented from signing the document until it is their turn in the signing order. The document need not be final in this embodiment. Historically, users must wait until a document is considered “final” before applying their signature, and the signing order is defined by the Originating Party and one cannot sign a document until all changes have been agreed to and a document is considered final.

In one embodiment of the electronic signature creation system, this sequence of operations may be altered. Specifically, some embodiments of the electronic signature creation system create a workflow in which one party can apply their signature to a document, but their signature will not be applied to the document until a subsequent action takes place. Thus, in one such embodiment, a user (e.g., “Party A”) makes changes to a document and signs the document; however, the signature of Party A is not applied until the opposing party (“Party B” in this example) “approves” those changes. In another embodiment, a user (e.g., “Party A”) signs a document but the signature of Party A is not applied until the opposing party (“Party B” in this example) “signs” first. Overall, the ability to sign and store a signature subject to a subsequent action covers number embodiments that are described in further detail below.

In one embodiment of the electronic signature creation system, an electronic signature is applied to a document. In such an embodiment, the electronic signature is watermarked with a document ID number that is unique to the document which the user applied their signature. This security feature of the electronic signature creation system prevents the copying of a user's signature from one document and applying the user's signature to a different document. Further embodiments that employ this feature are described in further detail below.

Another embodiment of the electronic signature creation system addresses document submission and workflow with respect to signature creation and application/merger with the document. In one example, a user is invited to collaborate on a document. Each document has a unique ID that is imbedded in a document's metadata. In one embodiment, the electronic signature creation system combines (e.g., concatenates) a user's email with the unique document ID number to generate a unique key that associates a document update to a specific contract/deal, even when the document update is submitted to a general email address. Thus, in one embodiment, the document ID+user email is a unique token that can associate any document or version number with the applicable contract/deal/project to which it relates.

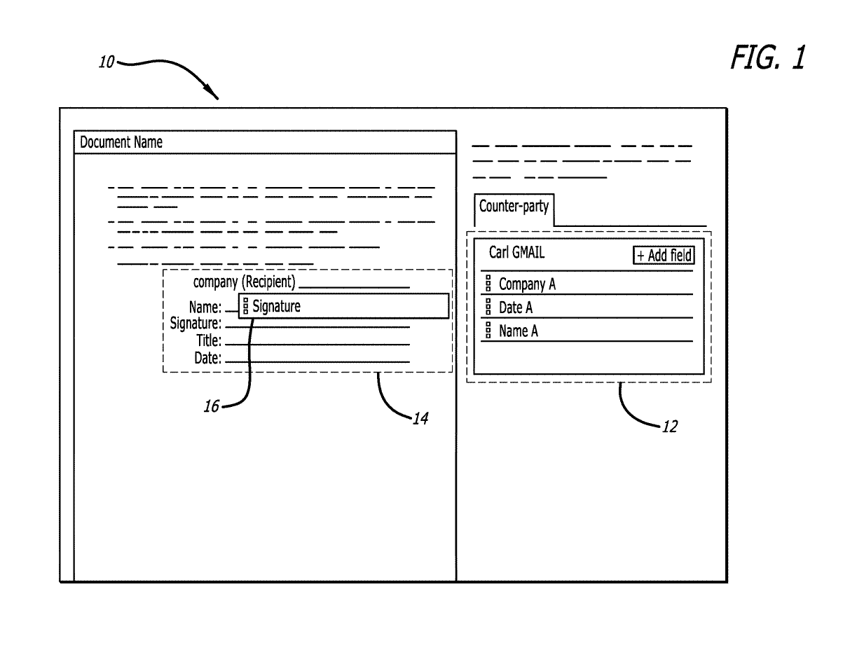

Referring now to the drawings, wherein like reference numerals denote like or corresponding parts throughout the drawings, and more particularly to FIGS. 1-3, various embodiments of the contract management process are shown. This method allows for users to create, upload, download, manage, negotiate, sign, and otherwise use the convenience of one screen to control, edit, and manage unique fields. In some embodiments, the system automatically stores historical versions of a document and ensures that users are using the most recent version within a given contract, deal, or project.

Referring to FIG. 1, in one embodiment of the electronic signature creation system 10, a particular field, object, image, or text image is dragged from a first location 12, to a second location 14, where the second location 14 equates to a specific location on a static image of an applied document. In some embodiments, as used herein, a document may refer to one or more of the following non-exclusive examples: any type of Microsoft Office Document (Word, Excel, PowerPoint, OneNote) or any plan, sketch, data, synopsis, graphic representation, drawing, design, or any combination thereof, or the like.

FIG. 1 is a diagram of the application of certain fields to a static document according to one embodiment. A Static Document may be either a fixed image (PNG, jpeg, PDF or any other stationary document) or a rendered image and is the median by which a user defines the location of an item on the document. The field which is chosen (1) can be any type of input, letter, name, initial, signature, image, picture, or other unique aspect that must be inputted later in the process. A user can chose 1 or more fields. When a given field is dragged onto a static image by the user, the placement of that Field corresponds to a unique X, Y coordinate 16 in the document. Since the document is a static image, users are able to place multiple fields, and the system is able to communicate the location(s) of field(s) to a non-static document based on its X, Y coordinates in the static document. The ability to identify both the location and type of field on one hand and communicate that location to a non-static document on the other hand is enabled by the electronic signature creation system. This embodiment of the electronic signature creation system also covers the two-way communication between a static document and non-static document. We addressed specifics on a one-way communication (static image to non-static image), but this embodiment also addresses two way communications including from a non-static image to a static image (and back and forth). Within a static image, the same logic applies, where this embodiment of the electronic signature creation process can communicate the location of predetermined field(s) to a non-static image. Once in the non-static image, users can manipulate, alter or otherwise modify particular fields so as to create an iterative process. Once the non-static document is converted back to a static document, the fields are inserted at their unique locations and can then be manipulated.

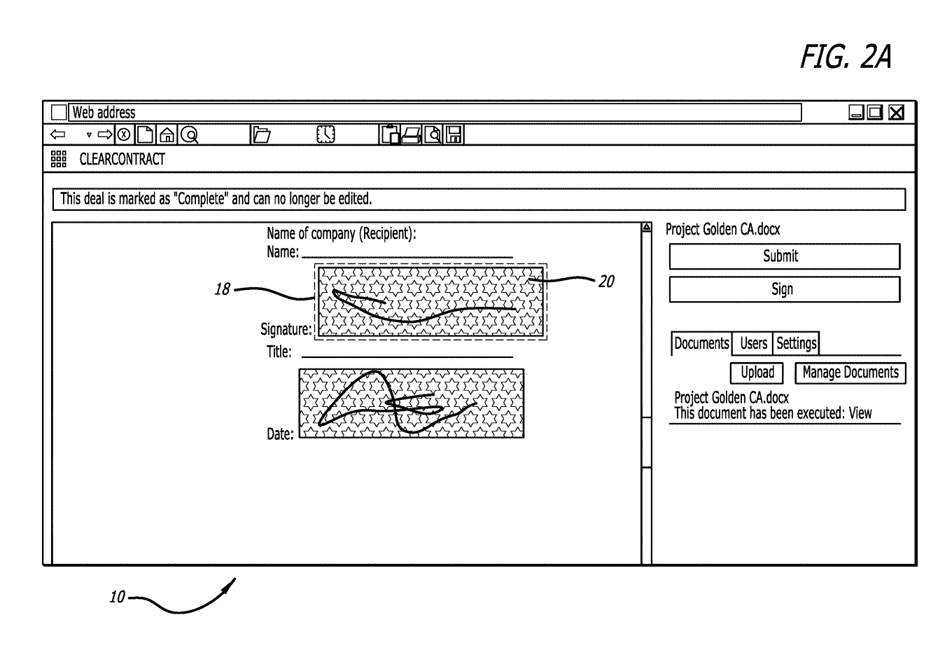

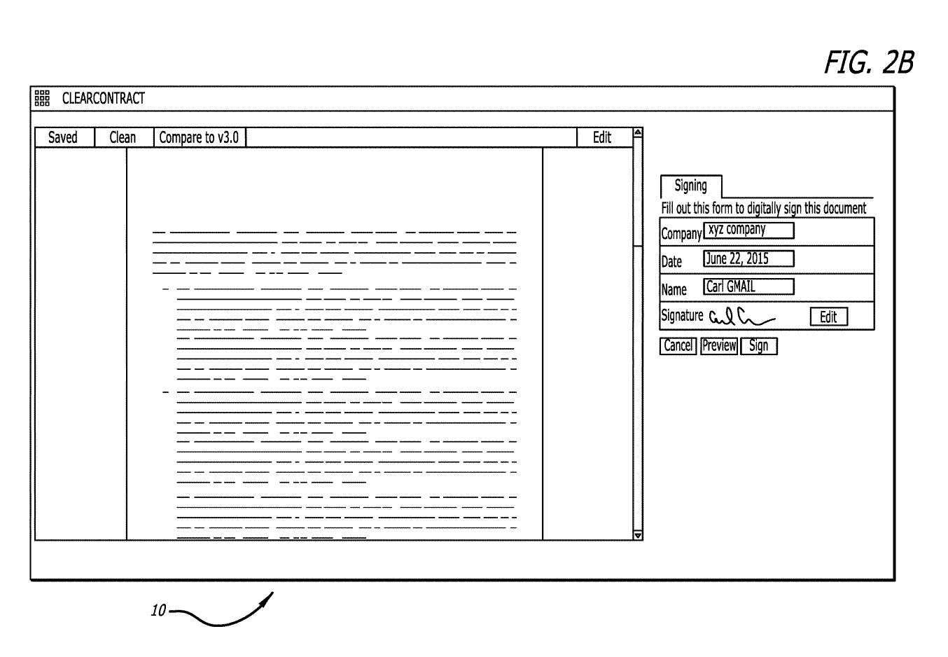

FIG. 2A is an illustrative example of one embodiment of the electronic signature creation system 10 where a user's signature 18, which was previously applied, is inserted into the document. The details of applying the signature 18 are shown in FIG. 2B. Applying a unique watermark 20 as background to an image, picture, signature, or any other object that corresponds to a person, date, time and particular document is included in this embodiment. As an example, a user will input information required, such as the original creation of signature prior to applying to the document, as seen in FIG. 2B. The information, including the original signature, is applied to the document as shown in FIG. 2A, with specific relevant information.

Typically, in other systems outside of the present disclosure, a document must be finalized and marked as complete before a signature can be applied. In contrast, embodiments of the electronic signature creation system disclosed herein involve the streamlining of unique aspects of document editing, collaboration, and execution, subject to some further action that the user may or may not control. In one example, a user within Party B receives a document from Party A. The user within Party B makes alterations to the document. The user within Party B can apply its signature to the document and although signed, its signature is not applied to the document until Party A accepts its proposed changes. In one embodiment of the transaction, the catalyst to apply the signature is the approval of changes, but in other embodiments, different actions are the catalyst to the application of the signature, such as a separate individual's signature, an approval, time lag, verification, or other third party action. Thus, in various embodiments of the electronic signature creation system, each one of these actions, either individually or in combination, may be used as the catalyst to the application of the signature.

In one embodiment, the Originator of a document creates a document and sets the signing order as Party B, then Party A. To facilitate the negotiation, Party A can pre-emptively sign the document in its relevant location. The system will hold these signatures in escrow and release the signatures upon ensuring that the Recipient does not make any changes and signs the document. Both the ability to hold signatures in escrow on one hand and define the catalyst for release of the signatures on the other hand are covered in this scenario. The same logic can be used for multiple signers, or multiple parties, who would apply multiple signatures and have one or more catalyst to release items held in escrow.

In certain embodiments, the catalyst for release of signatures held in escrow can include various pre-defined actions. This can include, but is not limited to, approval from a manager or other third party, signature from a counterparty, wiring of funds, an agreed upon action with a counterparty (i.e. a merger acceptance, a marriage, a divorce, an employment expiration, etc.) or some pre-defined time horizon.

In embodiments where multiple parties or multiple signers per party are included, the logic outlined above is consistent. The Originator of a document sets the signing order, (Party B, Party C, then Party A) or (Party B and C, whose order does not matter, then Party A), whose structure and order is defined in a logic tree. Signatures can be applied in any order, will be held in escrow until all signatures are collected, then released in that order as long as the predetermined conditions are met (typically that a document is not altered). As in the first example (Party B, Party C, then Party A) with Party A being the originator, Party A can sign the document first, but their signature is not applied until after Party B and Party C both sign an unaltered document. One further iteration of this example is there are multiple signers per party, with consistent logic that all signers within a party are released upon approval a predefined condition.

In one embodiment of the electronic signature creation system, Party A proactively applies their signature subject to the signing of Party B. Party A's signature will only be applied subject to the insertion of Public B's signature to the original agreement. Thus, in some embodiments of the electronic signature creation system, the system receives a signature (or other ID object) from a first user that is securely linked to a location in a document (so that the signature may not be placed at any other location or in any other document), but not actually placed at that position in the document where the signature will be merged with the document, until after the counterparty signs the document (or another catalyst action or combination of catalyst actions occurs). When the counterparty signs the document (or another catalyst action or combination of catalyst actions occurs), then the signature of the first user is merged with the document at the location to which it was securely linked. In other prior systems, a document is merely viewed as a single layer while the signature is simply overlaid as a second layer, but without any merger of the layers or security linking the signature to the exact position in the document.

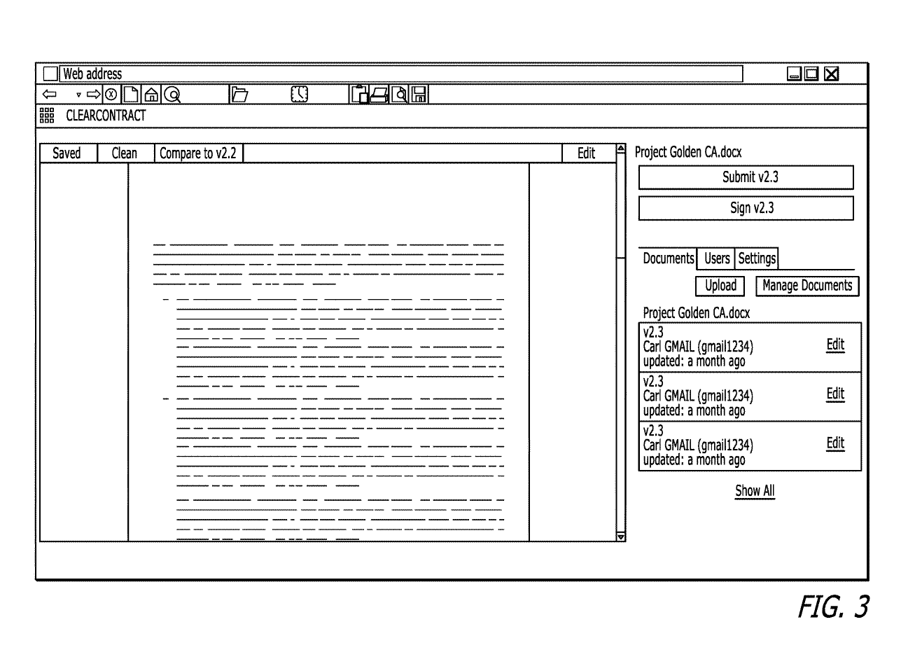

Referring now to FIG. 3, versioning, permissions and access are key elements in any transaction. As described above, a deal/contract/project can include numerous parties with multiple users per party. Permissions for each party can include if the party is viewable to the counterparty, whether the party can edit the document, has signing permissions or has the ability to submit from the application or submit from email. Segmenting permissions on a user and party basis provides a hierarchy of permissions. Specifically, in one embodiment of the electronic signature creation system, documents saved within one party are saved in their native format. Once the document is shared or submitted to a counterparty, the metadata associated with the document is cleansed to ensure confidentiality of information between one party and another party (e.g., counterparty). When scrubbing metadata, special attention is given to information pertaining to internal users that are identified as hidden from the opposing party. In this embodiment of the electronic signature creation system, information pertaining to the hidden user is either removed from the document or is identified as coming from the document owner (depending on settings of the hidden user). The flexibility to determine unique permissions on a user or group basis on the one hand and apply those permissions uniquely or across a group on the other hand are covered by this application.

In certain embodiments, the system may be accessible via a website over the Internet. It has also been contemplated that the system can be an application downloaded to a computing device, such as a tablet or smartphone. Pages of the website or the application can be stored on a server. Data obtained from the Originator of the document including the document and the signing order can be stored on the server or on a database that is in communication with the server. A back-end computer may also be in communication with the server to access and edit information stored on the server and/or database. The back-end computer may be remote or local. The server or the back-end computer may be used to edit the document or the order of signature. Furthermore, the server or the back-end computer may analyze document to determine if it has been altered or if signatures have been added. The server of the back-end computer may be able to send the document to the next signee in the order specified by the Originator. The server can also be used to inform all parties automatically after each signature is captured on the document or the documents becomes altered by one of the parties. In addition, the server can automatically inform all parties once all signatures are obtained for a document.

The server may be connected to the Internet or other type of network. In this way, party computers or business computers can access the server through a dedicated website or application on a computing device. Mobile devices, such as cell phones, smart phones, tablets, and other computer devices, can access and receive information from the server through the Internet as well.

The foregoing description, for purposes of explanation, uses specific nomenclature and formula to provide a thorough understanding of the disclosed embodiments. It should be apparent to those of skill in the art that the specific details are not required in order to practice the invention. The embodiments have been chosen and described to best explain the principles of the disclosed embodiments and its practical application, thereby enabling others of skill in the art to utilize the disclosed embodiments, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

While various embodiments have been described above, it should be understood that they have been presented by way of example only, and not limitation. Thus, the breadth and scope of a disclosed embodiment should not be limited by any of the above-described exemplary embodiments, but should be defined only in accordance with the following claims and their equivalents.

What is claimed:

1. A method comprising:
sending an invitation, by a first computing device, to a second computing device over a network to view, edit, and sign a file;
allowing a user to open the file after acceptance of the invention on the second computing device, and allowing the user to view, edit and sign the file;
processing, by the first computing device, the file to determine a magnitude of changes;
removing, by the first computing device, all metadata and associated user-specific information upon submission of the file from the second computing device to the first computing device.

2. The method of claim 1, wherein the first computing device is a server.

3. The method of claim 1, wherein the file is of a format selected from the group consisting of PDF, Microsoft Excel, Word, and PowerPoint.

4. The method of claim 1, wherein the processing is spread among a plurality of computing devices connected over the network, and wherein the plurality of computing devices includes the first and second computing devices.

5. A method for applying a unique identifier to an applied signature, the method comprising:
applying a unique merged field to a static document and determining a location, size, and placement of the unique merged field;
using a location of a placed image on a static image to populate a same location on a non-static image; and
inserting the unique merged field, image, or other object that matches the location of the placed image on the static image.

6. The method of claim 5, wherein the unique merged field is applied to a static document by dragging and dropping.

7. The method of claim 5, wherein the document contains a plurality of fields corresponding to various data fields belonging to individual users.

8. The method of claim 5, further comprising:
creating a watermark with unique document specific information or encryption key as a background to an applied signature; and
watermarking the document with an associated encryption upon signature placement.

9. The method as set forth in claim 8, further comprising applying an object to the document.

10. The method as set forth in claim 8, further comprising applying an image to the document.

11. The method as set forth in claim 8, further comprising applying a photo to the document.

12. A method for pre-determining a signing order for applying a signature to an electronic document, the method comprising:
receiving applied signatures for the electronic document at a document creator processor of a computing device;
holding the applied signatures in escrow until completion of all actions pre-determined by the document creator processor;
applying escrowed signatures upon the completion of all actions pre-determined by the document creator processor; and
removing all escrowed signatures and invalidating escrows signature data by the document creator processor in the event of further editing of the document.

13. A method for pre-determining the signing order for applying an ID object to a document, the method comprising:
creating a signing order of a document that requires a first user ID object before a second user ID object;
receiving the second user ID object for the document prior to submission of the document to the first user;
enabling the first user to edit and sign the document; and
applying the second user ID object only upon the completion of the first user ID object to the document.

14. The method of claim 13, wherein the document is selected from a group consisting of: any type of Microsoft Office Document (Word, Excel, PowerPoint, or OneNote), plan, sketch, data, synopsis, graphic representation, drawing, design, and a combination thereof.

15. The method of claim 13, wherein more than one user must apply an ID object to the document before the second user ID object.

16. The method of claim 13, further comprising approving a catalyst for applying an ID object to the document by a manager.

17. The method of claim 13, wherein the first user is a document recipient and the second user is a document originator, and wherein the signing order includes more than one document recipient followed by more than one document originator.

18. The method of claim 13, wherein the first user is more than one recipient groups and the second user is one or more originator groups, and the signing order requires all users of the more than one recipient group followed by all users of the one or more originator groups.

19. The method of claim 13, wherein the ID object is a signature.

20. A method for managing versions, permissions, and access to a document during a collaboration process among multiple parties with multiple users per party, the method comprising:
segmenting permissions on a user and party basis to enable a hierarchy of permissions;
cleansing metadata associated with the document to ensure confidentiality of information before sharing a document with other users;
identifying information pertaining to internal users that are identified to be hidden from the other party; and
removing information pertaining to a hidden user from the document, wherein metadata from hidden users is removed to other visible parties to maintain confidentially of hidden users.
